(19) United States
(12) Patent Application Publication
(10) Pub. No.: US 2011/0221081 A1
(43) Pub. Date: Sep. 15, 2011

(54) MANUFACTURING METHOD OF A HIGH-RELIABILITY OPTICAL FIBER COUPLER

(75) Inventors: Wei Wang, Beijing (CN); Dongfa Ding, Beijing (CN); Jing Li, Beijing (CN); Cun Wang, Beijing (CN); Lianjie Shan, Beijing (CN)

(73) Assignee: BEIJING AEROSPACE TIMES OPTICAL-ELECTRIC TECHNOLOGY CO., LTD., Beijing (CN)

(21) Appl. No.: 13/002,062

(22) PCT Filed: Dec. 31, 2008
(86) PCT No.: PCT/CN2008/073892

§ 371 Date: Dec. 30, 2010

(30) Foreign Application Priority Data
Nov. 19, 2008 (CN) 200810226869.2

(51) Int. Cl. G02B 6/26

(52) U.S. Cl. 264/1.25

(57) ABSTRACT

A manufacturing method of a high-reliability optical fiber coupler includes (1) manufacturing the optical fiber coupler by a fused biconical tapering process employing a parallel sintering process, and detecting via a tension test the strength of the optical fiber resulting from the sintering process, securing the strength thereof being greater than or equal to 1N; (2) fixing both ends of the sintered optical fiber coupler in a U-shaped quartz groove via hardening adhesive, and filling inside of the U-shaped quartz groove around the coupling arm at both ends thereof with adhesive to shorten the suspending length of the optical fiber; (3) inserting the U-shaped groove containing the optical fiber coupler into a circular quartz tube, and fixing both ends of the circular quartz tube via hardening adhesive; and (4) sleeving a stainless steel tube around the circular quartz tube, and sealing both ends of the stainless steel tube.

### FIELD OF THE INVENTION

The present invention relates to a manufacturing method of an optical fiber coupler. An optical fiber coupler may act as a shunt or a combiner for a light signal, and is therefore widely used in optical fiber gyroscopes, optical fiber hydrophones, optical fiber current sensors, and other optical fiber sensing fields.

### BACKGROUND OF THE INVENTION

An optical fiber coupler may act as a shunt or a combiner for a light signal, and therefore is widely used in the optical fiber communication field and optical fiber sensing fields, such as optical fiber gyroscopes, optical fiber hydrophones and is optical fiber current sensors.

The operating principle of an optical fiber coupler is based on the evanescent field theory and the optical waveguide mode coupling theory. The fused biconical tapering method for manufacturing an optical fiber coupler comprises: putting together two optical fibers with claddings removed side by side in a parallel or kinked way; heating the optical fibers with a flame such that the fibers fuse; and meanwhile stretching the optical fibers toward two sides at a specific speed, thus gradually thinning the part of the optical fibers in the local heating zone so as to assume a biconical taper shape, in such a way to couple transmitting power due to outward expansion of the evanescent field. The following process steps are so-called parallel sintering or kinked sintering process steps of the fused biconical tapering process. Under the assumption that one optical fiber is a disturbance to another optical fiber, and under the approximation of weak coupling, the coupling equations are as below:

$$\{ \begin{matrix}\frac{d {A}_{1} ( z )}{d z} = i ( {β}_{1} + {C}_{11} ) {A}_{1} + i {C}_{12} {A}_{2} \\ \frac{d {A}_{2} ( z )}{d z} = i ( {β}_{2} + {C}_{22} ) {A}_{2} + i {C}_{21} {A}_{1}\end{matrix}$$

wherein Aₗ and A₂ are mode field amplitudes of the two optical fibers, respectively; and β₁ and β₂ are propagation constants of the two optical fibers in an independent state, respectively. Actually, the self-coupling coefficients can be ignored when compared to the mutual coupling coefficients, that is, approximately, C₁₁=C₂₂=0, and C₁₂=C₂₁.

FIG. 1 illustrates the curve indicating the relationship between the splitting ratio of the optical fiber coupler and the length of the fused biconical taper (wherein a stands for the primary fiber, and b stands for the secondary fiber). The two optical fibers start to get closer with the increase of the extension length. Light begins to couple between the two optical fibers when the two optical fibers are close to a specific extend. Furthermore, the coupling amount of the light changes with the increase of the extension length.

After the sintering process, the two fused optical fibers are suspended and fixed in a U-shaped quartz groove under a certain tension. This results in a chord-like structure, which possesses a certain inherent resonant frequency that correlates with the chord length of the optical fiber. The longer the chord length of the optical fiber is, the lower the inherent resonant frequency and the worse the resistance against impacts.

The fused biconical taper method lends itself to mass production, and presents advantages of a firm structure, a good environmental performance, a low additional loss, and so on. However, different combinations of two parameters, that is, the flame temperature field and the extension speed in the sintering process, will cast different influences on the optical fiber strength resulting from the sintering process. In the traditional manufacturing process, there is neither requirement on the detecting process of the optical fiber strength, nor control on the suspending length of the optical fiber in the coupler. Therefore, the resistance against impacts can be guaranteed only to a certain extend, thus not satisfying a high requirement on resistance against impacts.

Moreover, the two optical fibers are combined together tightly in a kinked way in the above-mentioned kinked sintering process of the manufacturing method, resulting in a relatively large torsional stress at the kink points on both sides. Especially when manufacturing a small coupler, the torsional stress is even larger due to the fact that the two kink points are even closer to each other. In addition, both sides of the biconical taper zone of the coupler are located at the outer edge of the flame in the sintering process, leading to larger inner stresses in the optical fibers. Therefore, the coupler degrades in its reliability since the coupling arm is prone to fracture failure under the action of an external impact stress. Through the above-mentioned parallel sintering process of the manufacturing method, the problem associated with the torsional stress is overcome, and thus the reliability is improved remarkably. In the fused biconical tapering method, meanwhile, the thermal peeling process or other nondestructive peeling process is employed to remove the optical fiber cladding, a quality check is performed on the optical fiber cladding after the peeling process, and a quality check is conducted on the internal optical fiber after biconical tapering is finished, all of which contribute to an optical fiber coupler of high reliability.

Encapsulation will be performed after the optical fiber coupler is sintered. In the traditional encapsulation method, the parts of the optical fiber which are clad and located at two ends thereof are fixed in one single quartz groove; then the quartz groove is inserted into a circular quartz tube; and finally a stainless steel tube is sleeved around the circular quartz tube to provide protection, with both ends encapsulated with adhesive. This encapsulation method does not employ any shock absorption measures, thus leading to an optical fiber coupler of poor resistance against impacts that can hardly satisfy the requirement for applications necessitating a high resistance against impacts (such as the situation in which the impact acceleration is higher than 3000 g, and the impact frequency ranges from 1000 to 5000 Hz).

In Chinese patent No. 92108997.X titled A Method of Reinforcing Optical Fiber Coupler, the reliability of the optical fiber coupler is improved by reinforcing the substrate. In Chinese patent No. 94100528.3 titled Protective Structure and Protection Method of An Optical Fiber Coupler, the optical fiber coupler is encapsulated through a box and a bulge supporting the optical fiber, with the box being made of a kind of material having the same thermal expansion coefficient as the optical fiber. Even though the methods disclosed in the two patents mainly solve the problem associated with temperature stability, they are complicated in the encapsulation process and cost high in encapsulation material. In addition, neither patent comments on the reliability and the resistance against large impacts of the encapsulation structure.

### SUMMARY OF THE INVENTION

The purpose of the present invention is to provide a manufacturing method of an optical fiber coupler that can overcome the shortcomings of the prior arts and improve reliability of the optical fiber coupler.

The technical solution of the present invention is to provide a manufacturing method of a high-reliability optical fiber coupler, and the method comprises the following steps:

(1) Manufacturing the optical fiber coupler by a fused biconical tapering process which employs a parallel sintering process, and detecting via a tension test the strength of the optical fiber resulting from the sintering process, securing the strength of the optical fiber being equal to or larger than 1 N;

(2) fixing both ends of the sintered optical fiber coupler in a U-shaped quartz groove via hardening adhesive, and filling inside of the U-shaped quartz groove around the coupling arm at both ends thereof with adhesive to shorten the suspending length of the optical fiber;

(3) inserting the U-shaped quartz groove containing the optical fiber coupler mentioned in the step (2) into a circular quartz tube, and fixing both ends of the circular quartz tube via hardening adhesive; and

(4) sleeving a stainless steel tube around the circular quartz tube, and sealing both ends of the stainless steel tube.

The hardening adhesive in steps (2) and (3) is thermosetting adhesive.

The following step is further carried out after step (3):

(3)′ Putting the circular quartz tube in the step (3) into a high-temperature box for high temperature treatment, and the high temperature treatment is carried out at the temperature of 83° C.˜87° C. for 2˜3 hours; then is carried out at the temperature of 108° C.˜112° C. for 1˜2 hours.

The adhesive with which the inside of the U-shaped quartz groove is filled around the coupling arm at both ends in step (2) is ultraviolet adhesive.

The optical fiber cladding is removed by a thermal peeling process in the fused biconical tapering process of step (1), with the temperature at the sintering flame center in the parallel sintering process being above 1500° C., and the strength of the optical fiber after the sintering process is greater than or equal to 1 N.

The thermosetting hardening adhesive is epoxy resin adhesive.

The ultraviolet adhesive has a glass transition temperature below −50° C.

In step (4), the stainless steel tube is sleeved around the circular quartz tube after the circular quartz tube is clad with silicone rubber.

The difference between the external diameter of the circular quartz tube and the internal diameter of the stainless steel tube in step (4) is at least 0.6 mm, and the gap therebetween is fully filled with silicone rubber.

Results from a theoretic analysis conducted on the inherent frequency of 2×2 type optical fiber couplers with different chord lengths are illustrated in Table 1.

TABLE 1
Relationship between inherent frequency of 2 ×
2 optical fiber couplers and optical fiber chord length

| | Optical fiber chord length (mm) | | | | |
|---|---|---|---|---|---|
| Frequency (Hz) | 30 | 25 | 20 | 15 | 10 |
| First order | 1132 | 1718 | 1950 | 3243 | 5295 |
| Second order | 2768 | 3880 | 4176 | 6150 | 8948 |

The mechanical model in the situation that the optical fiber coupler is subject to an impact perpendicular to the optical fiber axis can be analyzed through material mechanics theories. In order to simplify the analysis, it is assumed that the two optical fibers sintered together inside the coupler are equivalent to a uniform beam of a certain length with both ends thereof fixed. The transverse force analysis model of the optical fiber coupler is as shown in FIG. 2.

As shown in FIG. 2, contraflexure occurs at points of 0.211l and 0.789l.

$${M}_{max} = \frac{{ql}^{2}}{24} \qquad ( 1 )$$

wherein Mₘₐₓ is the maximum bending moment in N·m, l is the chord length (m), and q is the uniform load (N/m).

The shearing forces at two ends, A and B, are Q_{A} and Q_{B}, respectively:

$${Q}_{A} = \frac{ql}{2} , {Q}_{B} = \frac{ql}{2} \qquad ( 2 )$$

The shearing stresses at points A and B are:

$$τ = \frac{4}{3} \frac{{Q}_{A}}{A} , τ = \frac{4}{3} \frac{{Q}_{B}}{A} \qquad ( 3 )$$

wherein A is the cross section area of the optical fiber.

At the occurrence of brittle fracture which is conditioned on the shearing stress reaching the strength limit of the optical fiber material, the shearing stress is given as blow:

$$τ = \frac{4}{3} \frac{{Q}_{A}}{A} = \frac{2}{3} \frac{ql}{A} = {σ}_{b} \qquad ( 4 )$$

wherein σ_{b} is the strength limit (yield strength) of the optical fiber material, measured in MPa.

When the suspension girder is subject to an impact at an acceleration of α, Equation (4) can be rewritten as:

$$\frac{2}{3} \frac{\frac{A d x ρ a}{d x} l}{A} = \frac{2}{3} ρ al = {σ}_{b} \qquad ( 5 )$$

In the Equation (5) dx is the unit length of the distributed load, and ρ is the density of the optical fiber material. The theoretical acceleration that the suspension girder can bear is as below:

$$a = \frac{3}{2} \frac{{σ}_{b}}{ρ l} \qquad ( 6 )$$

It can be derived from the Equation (6) that the impact acceleration that the optical fiber coupler can theoretically bear is inversely proportional to the length of the suspension girder of the optical fiber.

If ρ=2.5 g/cm³, l=30 mm and σ_{b}=40 Mpa, then the impact acceleration that the optical fiber coupler can theoretically bear is 80000 g.

As shown in the figure illustrating the force analysis model, the cross section is compressed at the upper part and tensed at the lower part, with the maximum bending moment Mₘₐₓ being directly proportional to the magnitude of the force and the square of the chord length. A reduction in the chord length leads to decreases in the maximum bending moment and the transverse shearing force. Even though the resistance performance against bending and transverse shearing worsens after the cladding is peeled off from the optical fiber, shortening the chord length can greatly improve the impact-resisting performance of the optical fiber coupler.

The present invention is advantageous in the following aspects in comparison with the prior arts:

(1) According to the present invention, an optical fiber coupler is manufactured by a fused biconical tapering process which employs a parallel sintering process, in this way large internal stress that could otherwise generated in the kinked sintering process is avoided. After the sintering process, the strengthen of the unencapsulated and unsolidified optical fiber is detected via a tension test, in this way the optical fiber coupler with the optical fiber strength greater than or equal to 1 N can be sorted out to avoid defective products emerging from the following process due to insufficient optical fiber strength such that the cost can be saved. Furthermore, both ends of the optical fiber coupler are fixed in the U-shaped quartz groove during the encapsulation process, and adhesive is filled around the optical fiber coupling arm to both sides of the coupling zone, in this way the suspending length of the optical fiber is shortened such that impact-resisting performance and resonance frequency of the optical fiber coupler are improved and the weak part of the coupling arm inside the coupler is protected. The present invention, through detecting the optical fiber strength during the manufacturing process and controlling the suspending length of the optical fiber inside the optical fiber coupler, renders thus-produced optical fiber couplers to comply with the requirement for high impact-resisting performance.

(2) In the embodiment according to the present invention, the temperature of the sintering flame center sintering the optical fiber coupler is higher than 1500° C., and the optical fiber cladding is removed by a thermal peeling process, thus sintering strength is enhanced and reliability of the optical fiber coupler is improved.

(3) In the embodiment according to the present invention, ultraviolet adhesive is filled around the coupling arm to both sides of the coupling zone. This processing manner facilitates filling, can be easily realized in the process, provides better protection to the weak part of the coupling arm to both sides of the coupling zone of the optical fiber coupler, shortens the suspending length of the optical fiber, and therefore increases resonance frequency, impact-resisting performance and reliability thereof.

(4) In the embodiment according to the present invention, the distance between the external diameter of the circular quartz tube and the internal diameter of the stainless steel tube is at least 0.6 mm, and the gap therebetween is uniformly filled with silicone rubber. In comparison with the prior arts where the stainless steel tube is directly sleeved around the circular quartz tube, the present invention, through increasing the gap between the circular quartz tube and the stainless steel tube and filling the silicone rubber of a certain thickness to enhance the shock absorption performance, improves impact-resisting ability of the device and thus the reliability of the optical fiber coupler as a whole.

(5) In the embodiment according to the present invention, the encapsulated circular quartz tube containing the optical fiber coupler is disposed into a high-temperature box for high temperature treatment, which effectively releases the internal stress generated by the optical fiber sintering during the fused biconical tapering process and the additional stress generated by thermosetting adhesive during the solidification and encapsulation process of the optical fiber coupler, thus improving temperature stability and reliability of the optical fiber coupler.

(6) The optical fiber couplers involved in the manufacturing method according to the present invention may include, but not limited to, single-mode, multimode and polarization-maintaining optical fiber couplers of 2×2 (1×2) and 3×3 (1×3) types, all of which can be improved in reliability via the method disclosed herewith during the manufacturing process.

### BRIEF DESCRIPTION OF THE DRAWINGS

FIG. 1 shows the curve indicating the relationship between the splitting ratio of the optical fiber coupler and the fused biconical taper length.

FIG. 2 shows a schematic diagram of the transverse force analysis model of the optical fiber coupler according to the present invention.

FIG. 3 shows a flow chart of a preferred embodiment of the manufacturing method of a high-reliability optical fiber coupler according to the present invention.

FIG. 4 shows a schematic diagram of the coupling arm and the coupling zone of the optical fiber coupler according to the present invention.

FIG. 5 shows a schematic diagram of the encapsulation of the optical fiber coupler according to the present invention.

FIG. 6 shows a sectional view along the line B-B in FIG. 5.

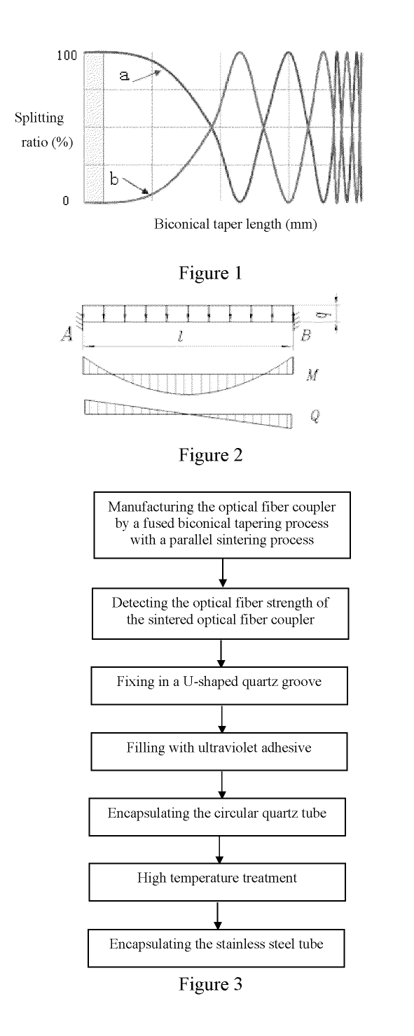

### DETAILED DESCRIPTION OF THE PREFERRED EMBODIMENTS

FIG. 3 shows a flow chart of a preferred embodiment of the manufacturing method of a high-reliability optical fiber coupler according to the present invention. Thereafter the manufacturing method according to the present invention will be described in detail. The manufacturing method includes the following steps:

(1) Manufacturing the optical fiber coupler by a fused biconical tapering process which employs a parallel sintering process, and detecting via a tension test the strength of the optical fiber resulting from the sintering process, securing the strength of the optical fiber equal to or larger than 1 N.

The thermal peeling method is employed to remove the optical fiber cladding during manufacturing the optical fiber coupler. The commonly used mechanical peeling method to remove the optical fiber cladding is prone to producing surface defects in the optical fiber cladding, thus lowering optical fiber strength and reliability. The oxyhydrogen flame is employed as the heating source in the sintering process of the fused biconical tapering method. Two heating methods may be employed. In one method, oxygen in the air and hydrogen are directly used for heating, leading to a temperature field of poor uniformity around the oxyhydrogen flame and a flame temperature of only 1100° C.˜1400° C. In another method, an additional channel of oxygen is employed to guarantee that the temperature of the oxyhydrogen flame reaches 1500° C.˜1700° C. Desirably, the process according to the present invention employs the second heating method, in which the input gas flows of hydrogen and oxygen are controlled via flow controllers, thus the sintering temperature being increased and the uniformity of the temperature field of the heated zone being improved. Meanwhile, a small-caliber flare head is used to reduce the extension length. The optical fiber strength of the optical fiber coupler is detected by means of tension detection method after the fused biconical tapering is finished.

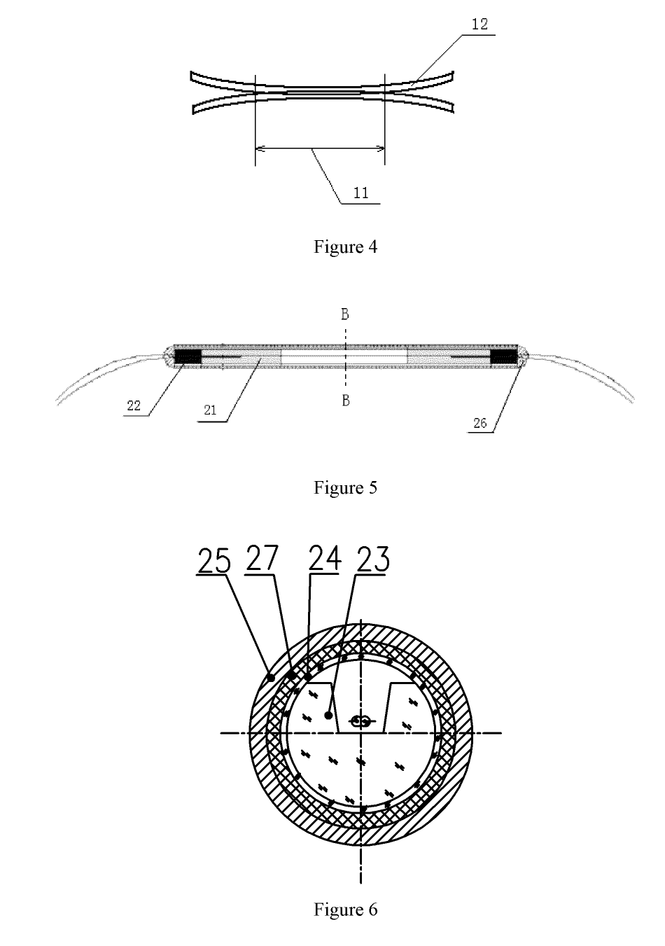

(2) Fixing both ends of the sintered optical fiber coupler in the U-shaped quartz groove via thermosetting adhesive, and filling ultraviolet adhesive 21 around the optical fiber coupling arm 12 to both sides of the coupling zone 11 in the U-shaped quartz groove, thus shortening the suspending length of the optical fiber, as shown in FIG. 4.

As shown in FIGS. 5 and 6, after the fused biconical tapering process is finished, the U-shaped quartz groove 23 is transferred to the region below the optical fiber coupler by the encapsulation device of the biconical tapering system; the encapsulation platform is hoisted such that the optical fibers fall at the exact central position of the U-shaped quartz groove 23; the positions on the outside wall of the U-shaped quartz groove 23, each of which is distanced from the furcation portions of the coupling zone 11 and the coupling arms 12 by 2 mm along the direction of the coupling arm 12, is marked by, for example, a red marker pen; the clad portions of the optical fibers that are located at two ends of the optical fiber coupler are then fixed with thermosetting adhesive 22 so as to fix the optical fiber coupler in the U-shaped quartz groove, with this section of thermosetting adhesive 22 being 2˜3 mm in length; and then ultraviolet adhesive 21 is uniformly applied into the parts of the U-shaped quartz groove 23 from the red markers outwards to the concluding points of thermosetting adhesive 22. This filling technology with ultraviolet adhesive 21 shortens the optical fiber suspending length of the optical fiber coupler inside the quartz groove, and increases the impact-resisting performance and resonance is frequency of the optical fiber coupler. After the solidification process is finished, the coupler is taken off from the encapsulation device, and an internal microscopic examination is conducted thereon with a stereomicroscope, so as to get rid of defective products, such as those presenting optical fiber cracks, or having bubbles inside the adhesive, in this way to guarantee the high reliability of the optical fiber coupler.

(3) Inserting the optical fiber coupler into the circular quartz tube 24, and fixing both ends of the circular quartz tube 24.

The optical fiber coupler solidified in the U-shaped quartz groove 23 is taken off from the encapsulation platform of the biconical tapering machine; the circular quartz tube 24 of a specific length is sleeved around the U-shaped quartz groove 23 along the pigtail fiber of the optical fiber coupler, with the requirement that both ends of the circular quartz tube exceed beyond the quartz groove, for example, by 1˜2 mm; then the U-shaped quartz groove 23 and the circular quartz tube 24 are adhered and fixed through applying thermosetting adhesive at both ends of the U-shaped quartz groove 23, as shown in FIGS. 5 and 6.

The thermosetting adhesive mentioned above may be 353ND epoxy resin adhesive. The purpose of employing this adhesive is to make the adhesive matched well with the optical fiber. Thermosetting adhesive of other types can also be employed, provided that this purpose can be fulfilled. Besides the thermosetting adhesive, other hardening adhesives, such as ultraviolet hardening adhesive, e.g., OE188 adhesive or NOA81 adhesive, can also be employed.

(4) Conducting high temperature treatment on optical fiber coupler.

Putting the optical fiber coupler sleeved with the circular quartz tube 24 into a high-temperature drying oven so as to apply high temperature treatment thereto. The treatment is carried out at the temperature of 83° C.˜87° C. for 2˜3 hours, generally for 2 hours; then is carried out at the temperature of 108° C.˜112° C. for 1˜2 hours, generally for 1 hour. Finally the drying oven is naturally cooled to the room temperature. The high temperature treatment can effectively release the stress in the fiber coupler produced during the fused biconical tapering sintering process and the encapsulation process.

(5) Sleeving the stainless steel tube 25 around the circular quartz groove 24 after the circular quartz tube 24 is clad with silicone rubber 27, ensuring that silicone rubber is uniformly distributed between the circular quartz tube and the stainless steel tube; and sealing both ends of the stainless steel tube with silicone rubber.

After the high temperature treatment, the optical fiber coupler is taken out of the high-temperature drying oven; silicone rubber 27 is uniformly applied onto the outside of the circular quartz tube 24; then the stainless steel tube 25 of a specific length is sleeved around the circular quartz tube 24, the stainless steel tube 25 may be chosen in such a way that each of the two ends thereof exceeds beyond the circular quartz tube 24 by 2 mm. The circular quartz tube 24 is rotated during sleeving the stainless steel tube 25 so as to ensure that the sandwiched silicone rubber 27 is uniformly filled. Silicone rubber is used as the sealing material 26 at both sides of the stainless steel tube 25. Silicone rubber 27 sandwiched between the circular quartz tube 24 and the stainless steel tube 25 acts to have a shock absorption effect on the optical fiber coupler, with the structure as shown in FIG. 6.

The manufacturing method of the present invention improves the reliability of the optical fiber coupler, especially it improves the resistance performance against large impacts. This is verified by a large number of tests, with the test verification data as shown in Tables 2 and 3. The nomenclature “failure” as used in the tables refers to internal fracture failure of the optical fiber. The optical fiber coupler of the present invention is increased in its impact-resisting performance from original 1500 g/0.5 ms to 5000 g/0.5 ms, in its drop impact height from original 1.2 meters to at least 2.0 meters, and in its resonance frequency from below 1300 Hz originally to at least 5000 Hz.

The high temperature treatment process of the present invention can further improve reliability of the optical fiber coupler, as well as its temperature stability. Verification tests are summarized as below:

Test condition. After the sintering process, the optical fiber strength of the is coupler without encapsulation and solidification is detected through a tension test to secure that the optical fiber strength of the optical fiber coupler is greater than or equal to 1 N; the optical fiber coupler is fixed in a U-shaped quartz groove via thermosetting adhesive during the encapsulation process; adhesive is filled around the coupling arm at both sides of the coupling zone, thus leading to the primarily encapsulated optical fiber coupler; and then inserting the U-shaped quartz groove containing the primarily encapsulated optical fiber coupler into the circular quartz tube, and both ends of the circular quartz tube is fixed via thermosetting adhesive, thus leading to the secondarily encapsulated optical fiber coupler. The following verification tests are performed on this condition. Test results are illustrated in Table 4, which compare the results from three processing conditions, i.e. the processing condition in which the high temperature treatment is not carried out, the processing condition in which the subject is kept at the temperature of 100° C. for 8 hours, and the processing condition in which the subject is kept at the temperature of 83° C.˜87° C. for 2 hours and then kept at the temperature of 108° C.˜112° C. for 1 hour as described in the embodiment of the present invention. Comparisons shown in Table 4 verify that, as compared to the other two processing conditions, the high temperature treatment process in the technical solution of the present invention improves the reliability of the optical fiber coupler and its temperature stability. This is because the internal stress generated by the optical fiber sintering during the optical fiber fused biconical tapering process and the additional stress generated by the thermosetting adhesive during the solidification and encapsulation process are effectively released through the high temperature treatment process of the present invention.

Moreover, optical fiber couplers manufactured by this method can work at temperature ranging from −50° C. to +85° C. They can endure temperature impacts (−55° C.˜+85° C.) more than 500 times. Their lifespan reaches 5000 hs even stored at high temperature of 85° C.

TABLE 2
Test comparisons with respect to drop
impact on optical fiber couplers

| | Height | | |
|---|---|---|---|
| Condition | 1.2 meters | 1.5 meters | 2.0 meters |
| Couplers | 0 failure from | 26 failures | 42 failures from |
| manufactured by the | total 42 | from total 42 | total 42 |
| prior process | | | |
| Couplers | 0 failure from | 0 failure from | 0 failure from |
| manufactured by the | total 43 | total 43 | total 43 |
| present process | | | |

TABLE 3
Test comparisons with respect to compact on optical fiber couplers

| | Test | |
|---|---|---|
| | Half-sine impact of | Half-sine impact of |
| Condition | 1500 g/0.5 ms | 5000 g/0.5 ms |
| Couplers manu- | 0 failure from total 23 | 12 failures from total 23 |
| factured by the | | |
| prior process | | |
| Couplers manu- | 0 failure from total 17 | 0 failure from total 17 |
| factured by the | | |
| present process | | |

TABLE 4
Test comparisons with respect to the effect of high temperature
treatment process on optical fiber couplers

| | Test | | | |
|---|---|---|---|---|
| | Temperature performance | | Reliability test | |
| | (−50° C.~+85° C.) | | | 500 times of |
| | Change in | | | Temperature |
| | Splitting | Change in | 85° C. , | impact |
| Condition | ratio | Additional loss | 5000 h | (−55° C.~+85° C.) |
| Couplers not subject | Average | Average | 2 failures | 1 failure from |
| to high temperature | value ≦ | value ≦ | from | total 11 |
| treatment | 5% | 0.20 dB | Total 11 | |
| Couplers stored at the | Average | Average | 1 failure | 1 failure from |
| temperature 100° C. | value ≦ | value ≦ | from total | total 11 |
| for 8 hours | 4% | 0.16 dB | 11 | |
| Couplers subject to | Average | Average | 0 failure | 0 failure from |
| high temperature | value ≦ | value ≦ | from total | total 11 |
| treatment according | 2% | 0.10 dB | 11 | |
| to the present | | | | |
| invention | | | | |

The optical fiber couplers involved in the manufacturing method according to the present invention may include, but not limited to, single-mode, multimode and polarization-maintaining optical fiber couplers of 2×2 (1×2) and 3×3 (1×3) types, all of which can be improved in reliability via the method disclosed herewith during the manufacturing process.

The content that is not described in detail in the present invention is obvious to the skilled in this field.

What is claimed is:

1. A manufacturing method of a high-reliability optical fiber coupler, wherein the method comprises the following steps:
(1) manufacturing the optical fiber coupler by a fused biconical tapering process which employs a parallel sintering process, and detecting via a tension test the strength of the optical fiber resulting from the sintering process, securing the strength of the optical fiber being equal to or larger than 1 N;
(2) fixing both ends of the sintered optical fiber coupler in a U-shaped quartz groove via hardening adhesive, and filling inside of the U-shaped quartz groove around the coupling arm at both ends thereof with adhesive to shorten the suspending length of the optical fiber;
(3) inserting the U-shaped quartz groove containing the optical fiber coupler according to the step (2) into a circular quartz tube, and fixing both ends of the circular quartz tube via hardening adhesive; and
(4) sleeving a stainless steel tube around the circular quartz tube, and sealing both ends of the stainless steel tube.

2. The manufacturing method of a high-reliability optical fiber coupler according to claim 1, wherein the hardening adhesive in steps (2) and (3) is thermosetting adhesive.

3. The manufacturing method of a high-reliability optical fiber coupler according to claim 2, wherein the following step is further carried out after step (3):
(3)′ putting the circular quartz tube resulting from step (3) into a high-temperature box for high temperature treatment, and the high temperature treatment is carried out at the temperature of 83° C.˜87° C. for 2˜3 hours; then is carried out at the temperature of 108° C.˜112° C. for 1˜2 hours.

4. The manufacturing method of a high-reliability optical fiber coupler according to claim 1, 2 or 3, wherein the adhesive with which the inside of the U-shaped quartz groove is filled around the coupling arm at both ends in step (2) is ultraviolet adhesive.

5. The manufacturing method of a high-reliability optical fiber coupler according to claim 1, wherein the optical fiber cladding is removed by a thermal peeling process in the fused biconical tapering process of step (1), with the temperature at the sintering flame center in the parallel sintering process being above 1500° C., and the strength of the optical fiber after the sintering process is greater than or equal to 1 N.

6. The manufacturing method of a high-reliability optical fiber coupler according to claim 2, wherein the thermosetting adhesive is epoxy resin adhesive.

7. The manufacturing method of a high-reliability optical fiber coupler according to claim 4, wherein the ultraviolet adhesive has a glass transition temperature below −50° C.

8. The manufacturing method of a high-reliability optical fiber coupler according to claim 1, wherein in step (4) the stainless steel tube is sleeved around the circular quartz tube after the circular quartz tube is clad with silicone rubber.

9. The manufacturing method of a high-reliability optical fiber coupler according to claim 8, wherein the difference between the external diameter of the circular quartz tube and the internal diameter of the stainless steel tube in step (4) is at least 0.6 mm, and the gap therebetween is fully filled with silicone rubber.

10. The manufacturing method of a high-reliability optical fiber coupler according to claim 2, wherein the adhesive with which the inside of the U-shaped quartz groove is filled around the coupling arm at both ends in step (2) is ultraviolet adhesive.

11. The manufacturing method of a high-reliability optical fiber coupler according to claim 10, wherein the ultraviolet adhesive has a glass transition temperature below −50° C.

12. The manufacturing method of a high-reliability optical fiber coupler according to claim 3, wherein the adhesive with which the inside of the U-shaped quartz groove is filled around the coupling arm at both ends in step (2) is ultraviolet adhesive.

13. The manufacturing method of a high-reliability optical fiber coupler according to claim 12, wherein the ultraviolet adhesive has a glass transition temperature below −50° C.
